(19) United States
(12) Patent Application Publication
(10) Pub. No.: US 2004/0201910 A1
(43) Pub. Date: Oct. 14, 2004

(54) Bathroom mirror frame assembly

(76) Inventor: Lin-Ho Liu, Taichung (TW)

Correspondence Address: CHARLES E. BAXLEY, ESQ., 90 JOHN STREET, THIRD FLOOR, NEW YORK, NY, 10038, US

(21) Appl. No.: 10/417,009

(22) Filed: Apr. 14, 2003

(51) Int. Cl. G02B 7/182

(52) U.S. Cl. 359/872; 248/466

(57) ABSTRACT

A bathroom mirror frame assembly has a pair of rings, a pair of balls disposed between the rings, a mirror disk inserted in a spacing between the rings, and each of the rings having a lower connection portion to be connected. A positioning frame surrounds the rings. The positioning frame has a pair of inner sockets engaging with the balls. A basket is disposed on a top portion of the positioning frame. An upper hook device is connected to the basket.

### BACKGROUND OF THE INVENTION

The present invention relates to a mirror frame assembly. More particularly, the present invention relates to a bathroom mirror frame assembly which has two rings to position a mirror disk.

A conventional bathroom mirror is often adhered on a wall. However, the conventional bathroom mirror cannot be removed from the wall. Furthermore, a user will place a plurality of articles on an area surrounding a sink. Therefore, the articles will be fallen into the sink easily.

### SUMMARY OF THE INVENTION

An object of the present invention is to provide a bathroom mirror frame assembly which has two rings to position a mirror disk easily.

Another object of the present invention is to provide a bathroom mirror frame assembly which has a mirror positioning frame engaging with a pair of rings in order to adjust an angle of a mirror disk easily.

Accordingly, a bathroom mirror frame assembly comprises a pair of rings, a pair of balls disposed between the rings, a mirror disk inserted in a spacing between the rings, and each of the rings having a lower connection portion to be connected.

### BRIEF DESCRIPTION OF THE DRAWINGS

FIG. 1 is a perspective view of a bathroom mirror frame assembly of a preferred embodiment in accordance with the present invention;

FIG. 2 is a perspective exploded view of a mirror device of a preferred embodiment in accordance with the present invention;

FIG. 3 is a perspective assembly view of a mirror device of a preferred embodiment in accordance with the present invention;

FIG. 4 is a sectional view taken along line A-A in FIG. 3; and

FIG. 5 is a sectional view taken along line B-B in FIG. 3.

### DETAILED DESCRIPTION OF THE INVENTION

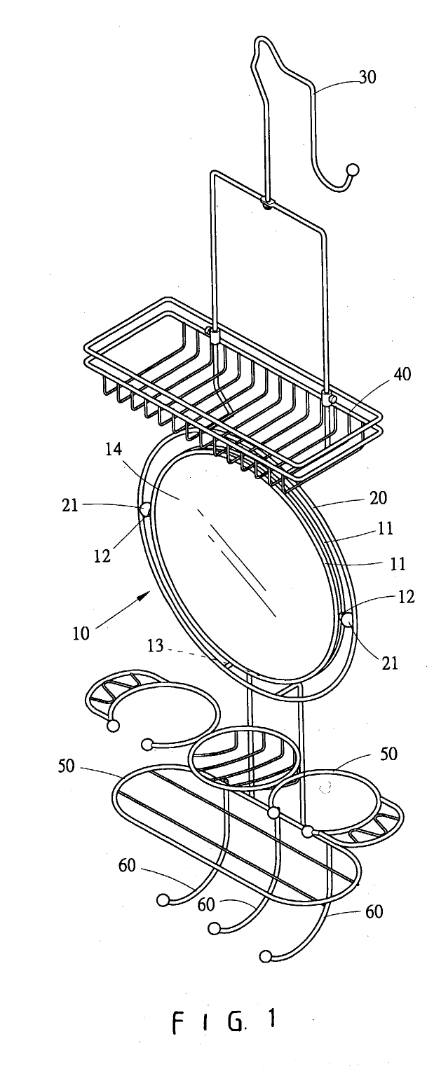

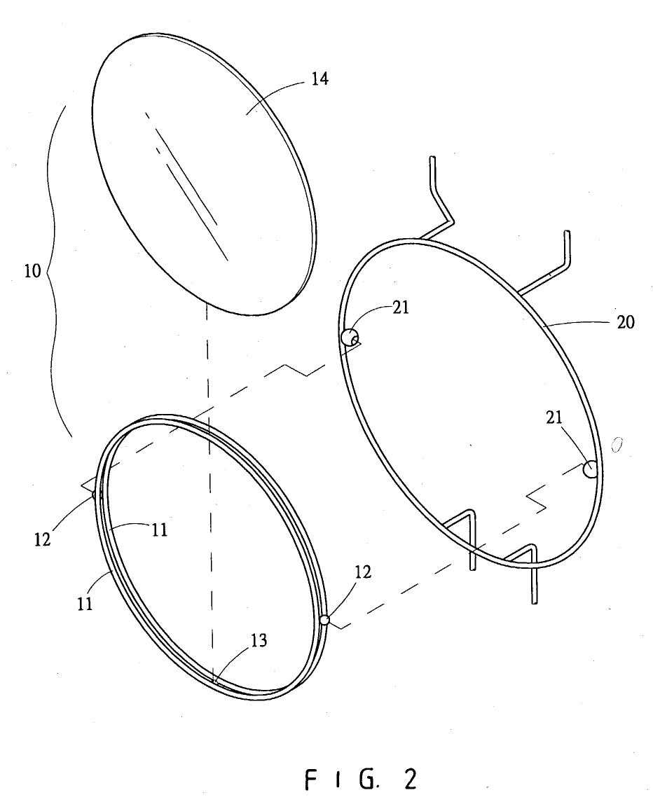

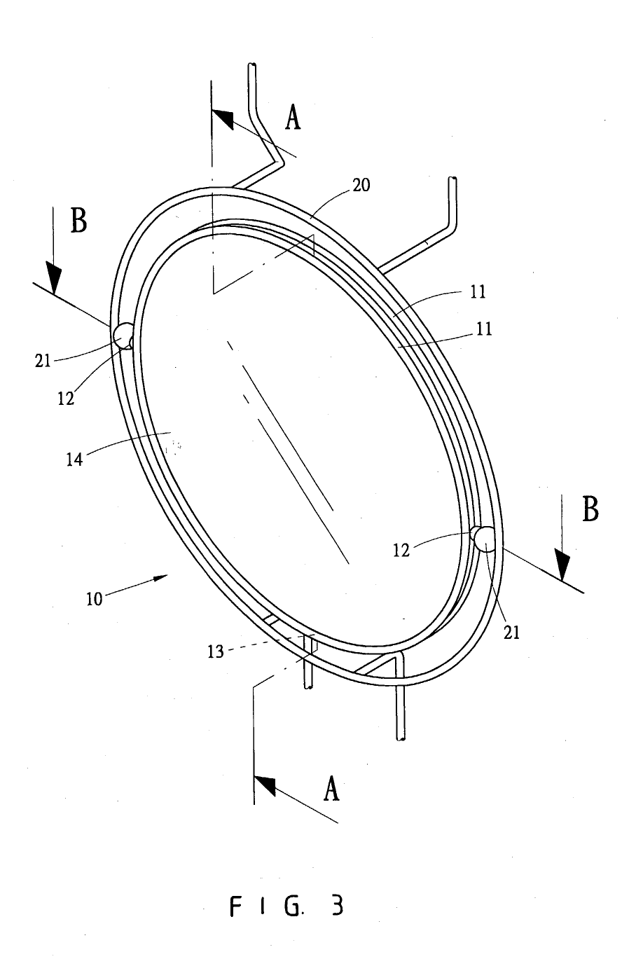

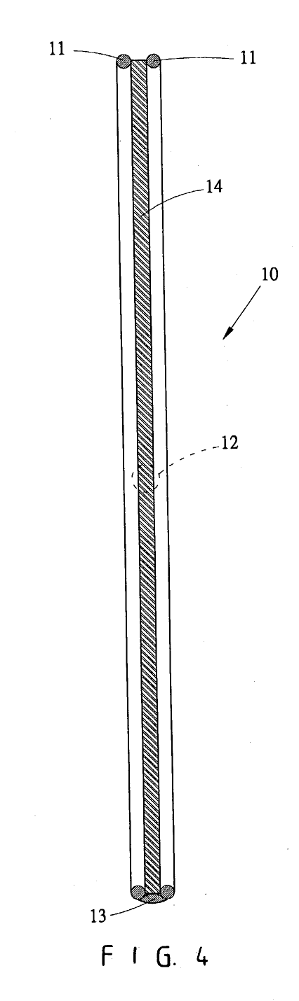

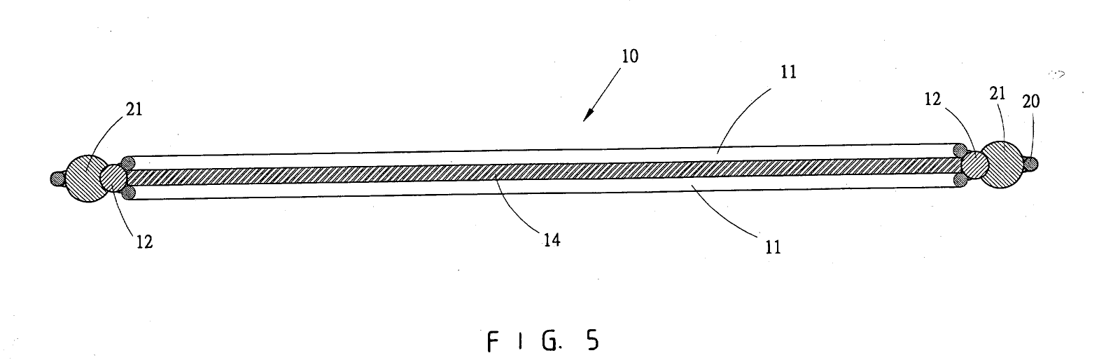

Referring to FIGS. 1 to 5, a bathroom mirror frame assembly 10 comprises a pair of rings 11, a pair of balls 12 disposed between the rings 11, a mirror disk 14 inserted in a spacing between the rings 11, and each of the rings 11 having a lower connection portion 13 to be connected.

A positioning frame 20 surrounds the rings 11. The positioning frame 20 has a pair of inner sockets 21 engaging with the balls 12.

A lower frame 50 is disposed on a bottom of the positioning frame 20.

The lower frame 50 has a plurality of lower hooks 60.

A basket 40 is disposed on a top portion of the positioning frame 20.

An upper hook device 30 is connected to the basket 40.

Each of the rings 11 is made of a metal, and each lower connection portion 13 is soldered.

Each of the balls 12 is soldered between the rings 11.

The invention is not limited to the above embodiment but various modification thereof may be made. Further, various changes in form and detail may be made without departing from the scope of the invention.

I claim:

1. A bathroom mirror frame assembly comprises:
a pair of rings,
a pair of balls disposed between the rings,
a mirror disk inserted in a spacing between the rings, and
each of the rings having a lower connection portion to be connected.

2. The bathroom mirror frame assembly as claimed in claim 1, wherein a positioning frame surrounds the rings, and the positioning frame has a pair of inner sockets engaging with the balls.

3. The bathroom mirror frame assembly as claimed in claim 2, wherein a lower frame is disposed on a bottom of the positioning frame.

4. The bathroom mirror frame assembly as claimed in claim 3, wherein the lower frame has a plurality of lower hooks.

5. The bathroom mirror frame assembly as claimed in claim 2, wherein a basket is disposed on a top portion of the positioning frame.

6. The bathroom mirror frame assembly as claimed in claim 5, wherein an upper hook device is connected to the basket.

7. The bathroom mirror frame assembly as claimed in claim 1, wherein each of the rings is made of a metal and each of the balls is soldered between the rings.

8. The bathroom mirror frame assembly as claimed in claim 1, wherein each of the rings is made of a metal and each said lower connection portion is soldered.
